(19) United States
(12) Patent Application Publication
(10) Pub. No.: US 2013/0132149 A1
(43) Pub. Date: May 23, 2013

(54) METHOD FOR QUANTITATIVE RESILIENCE ESTIMATION OF INDUSTRIAL CONTROL SYSTEMS

(71) Applicants: Dong Wei, Edison, NJ (US); Kun Ji, Plainsboro, NJ (US)

(72) Inventors: Dong Wei, Edison, NJ (US); Kun Ji, Plainsboro, NJ (US)

(21) Appl. No.: 13/703,158

(22) PCT Filed: Dec. 6, 2010
(86) PCT No.: PCT/US2010/059030

§ 371 Date: Feb. 7, 2013

Related U.S. Application Data
(60) Provisional application No. 61/353,411, filed on Jun. 10, 2010.

(51) Int. Cl. G05B 23/02

(52) U.S. Cl. CPC G05B 23/02; G06Q 10/0635
USPC 705/7.28; 340/3.1

(57) ABSTRACT

A three-layer model of an engineering system is proposed for developing and evaluating a resilient industrial control system incorporated within the engineering system, the model based upon a group of metrics that are cyclically estimated, operated and evaluated to create a valid resilient arrangement. The layers in the model include a human/operator layer, an automation layer and a process layer, where the industrial control system resides in the automation layer. The metrics are based upon the identification of a number of undesirable incidents, as well a determination of the frequency of occurrence of these incidents, their impact on the performance of the engineering system and the financial loss of the engineering system based upon these undesirable incidents.

### CROSS-REFERENCE TO RELATED APPLICATIONS

This application claims the benefit of U.S. Provisional Application 61/353,411, filed Jun. 10, 2010 and herein incorporated by reference.

### GOVERNMENT LICENSE RIGHTS

This invention was made partly with government support under Contract DE-FC26-07NT43313 awarded by the Department of Energy, Office of Electricity Delivery and Energy Reliability. The government has certain rights in the invention.

### TECHNICAL FIELD

The present invention relates to industrial control systems (ICS) and, more particularly, to a method and system for generating quantitative estimations of the resilience of a given industrial control system, including approaches to provide on-going enhancement of the resilience of an industrial control system during its engineering and operation phases.

### BACKGROUND OF THE INVENTION

Originally, the term “resilience” was studied in the files of ecology and psychology. The concept of resilience in ecological systems was first described by the Canadian ecologist C. S. Holling in order to draw attention to trade-offs between efficiency on the one hand and persistence on the other, or between constancy and change, or between predictability and unpredictability. Emmy Werner was one of the first scientists to use the term resilience in psychology, which refers to the ability to recover from trauma or crisis.

In recent years, the term resilience has been used to describe a movement among entities such as businesses, communities and governments to improve their ability to respond to and quickly recover from catastrophic events such as natural disasters and terrorist attacks. The concept is gaining credence among private and public sector leaders who argue that resilience should be given equal weight to preventing terrorist attacks in governmental security policies.

At times, terms such as resilience, robustness, adaptiveness, survivability, fault-tolerance and the like are used interchangeably. However, these terms are not considered to have the exact same meaning, although they may have some properties in common. For the purposes of the present invention, which precisely focuses on the properties of resilience, it is important to understand the subtle differences between each of these concepts.

“Robustness” of an industrial control system (ICS) is properly defined as permitting the ICS to function properly as long as modeling errors in terms of uncertain parameters and disturbances within the specific processes are bounded. “Adaptiveness” of an ICS is associated with permitting the ICS to function properly by adapting its control algorithms according to uncertain parameters associated with the specific processes. “Survivability” is the quantified ability of an ICS to continue to function during and after a natural or man-made disturbance. “Fault-tolerant” ICSs are focused on overcoming failures that may occur at any point in the system. In particular, fault-tolerant systems try to identify failure possibilities and take precautions in order to avoid them by any means without causing significant damage in the system.

While all of these individual concepts are important in understanding the operation of an industrial control system, they do not consider the presence of intelligent adversaries, such as “cyber attacks”. And unlike resilience, robustness, adaptiveness, survivability and fault-tolerance do not address how quickly the ICS recovers to normal operation after an incident. To date, there is no discussion or description of any methodology for understanding the resiliency of an industrial control system.

### SUMMARY OF THE INVENTION

The needs remaining in the prior art are addressed by the present invention, which relates to industrial control systems (ICS) and, more particularly, to a method and system for generating quantitative estimations of the resilience of a given industrial control system, including approaches to provide on-going enhancement of the resilience of an industrial control system during its engineering and operation phases.

In accordance with the present invention, a three-level model has been derived that allows for a plurality of metrics to be defined and measured to estimate the resiliency of a given industrial control system.

In particular and for the purposes of the present invention, a resilient industrial control system (RICS) is one that is designed and operated such that: (1) the frequency of undesirable incidents can be minimized; (2) most of the undesirable incidents can be mitigated; (3) the adverse impacts of the undesirable incidents can be minimized (in the case that the incidents themselves cannot be completely mitigated); and (4) the ICS can recover to normal operation in as short a time interval as possible.

A cyclic process is proposed that begins by identifying a set of critical undesirable incidents and performing a risk assessment for these incidents (in terms of their frequency and financial costs to the system). An ICS is then designed and implemented (referred to as “engineering”) to minimize each the identified critical undesirable incidents and the overall “business system” is operated with the engineered ICS. The system is then analyzed to see if there is a need to update the identification of the set of critical undesirable incidents, and the process cycles back to the risk assessment step. In a preferred embodiment of the invention, this cyclic process continues indefinitely.

Other and further aspects and utilizations of the exemplary methodology will become apparent during the course of the following discussion and by reference to the accompanying drawings.

### BRIEF DESCRIPTION OF THE DRAWINGS

Referring now to the drawings,

FIG. 1 is a block diagram of the three-layer methodology of the present invention;

FIG. 2 is a resilience curve associated with the implementation of the three-layer model in accordance with the present invention;

FIG. 3 is a flow chart of the cyclic process associated with creating a resilient industrial control system; and

FIG. 4 is a diagram of a security system framework configured to improve the cyber attack resilience of a power grid automation system.

### DETAILED DESCRIPTION

An industrial control system (ICS) is generally defined as an electronic device (or set of electronic devices) that function to monitor, manage, control and regulate the behavior of other devices or systems. Various ICS well-known in the art include Supervisory Control and Data Acquisition (SCADA) systems, Distributed Control Systems (DCS), Programmable Logic Controllers (PLCs) and the like.

For the purposes of the present invention, a “resilient” ICS is defined as an ICS that exemplifies all of the above-mentioned qualities of robustness, adapativeness, survivability and fault-tolerance, while also exhibiting the ability to quickly recover to normal operation from an undesirable incident. Adding resilience elements to an ICS is therefore focused on dealing with undesirable incidents. This requirement necessitates a control design strategy shift away from “reactive” methods to “proactive” methods, with consideration of assessing potential threats and taking necessary protection measures against them.

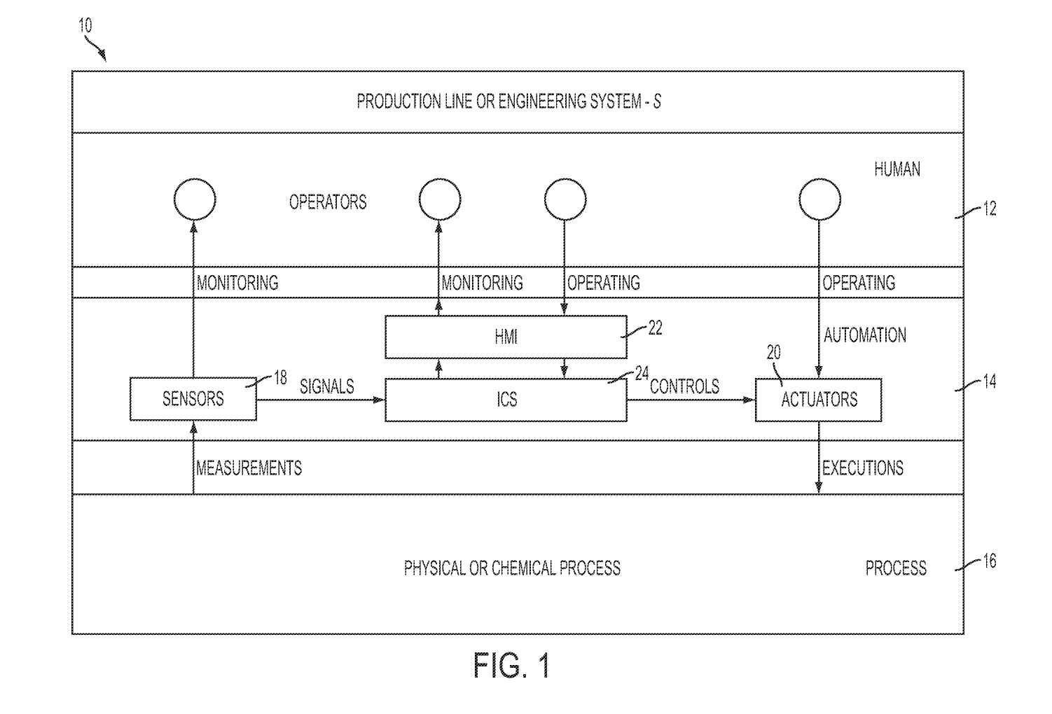

FIG. 1 is a block diagram 10 of an overall production line or engineering system S that is useful in visualizing and understanding the interaction of resilience with an exemplary ICS. Block diagram 10 is formed as a three-level model, including a human layer 12, an automation layer 14 and a process layer 16. As shown, process layer 16 sits at the bottom of the architecture, where a physical or chemical process (or any other suitable type of process) is monitored via one or more sensors 18 and is controlled by one or more actuators 20 residing in automation layer 14.

Human layer 12 is positioned at the top of the architecture, where operators monitor process data via either sensors 18 (i.e., a direct measurement of the performance of processes within process layer 16) or a Human Machine Interface (HMI) 22, both located within automation layer 14. Operators control the processes within process layer 16 via either actuators 20 (i.e., a direct control of one or more processes), or by inputting commands to HMI 22. As shown in FIG. 1, automation layer 14 is positioned in the middle of the three-layer model, as an interface layer between human layer 12 and process layer 16. An ICS 24 is part of automation layer 14 and communicates in an intra-level manner with sensors 18, actuators 20 and HMI 22. In particular, ICS 24 functions to collect real-time data of the controlled process(es) via sensors 18, provide status and diagnostic data to operators (at human layer 12) via HMI 22, receive commands and settings from operators via HMI 22, and control the process(es) via actuators 20.

By virtue of using this three-layer model in accordance with the present invention, it is possible to identify and estimate the various metrics associated with creating a resilient industrial control system.

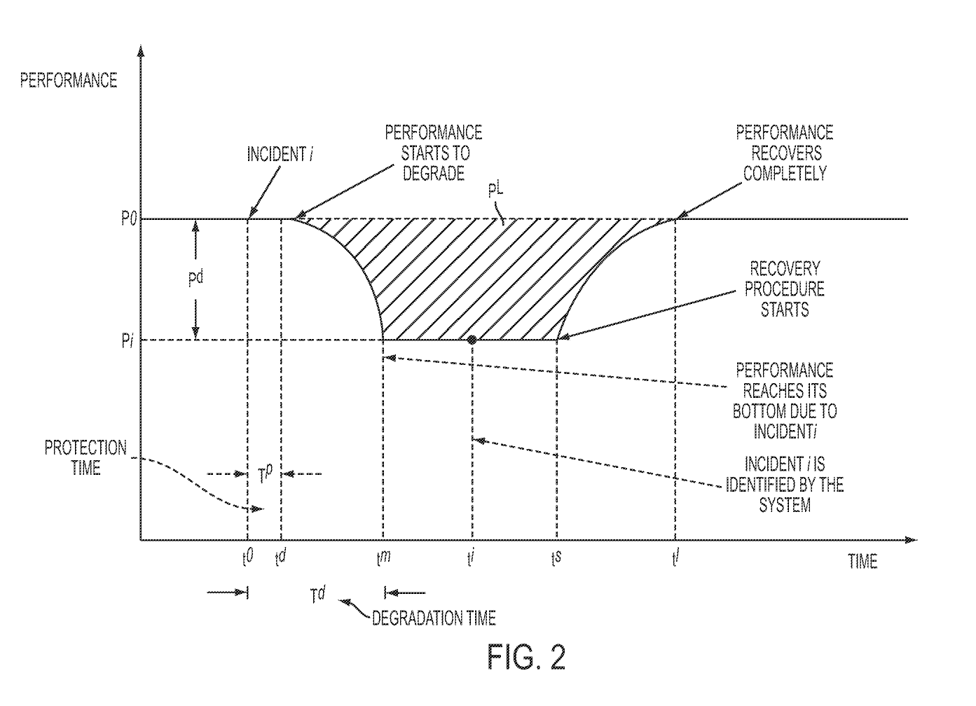

FIG. 2 is a resilience curve that is useful in understanding the estimation methodology of the present invention, showing the performance of a system as a function of time. The performance axis shows the performance of an entire system S (as opposed to the performance of only ICS 24), which is defined in this example as a function of production p and quality q using the following relation:

P(t)=f(p(t), q(t)).

With reference to FIG. 2, the first “event” indicated along the time axis is defined as an undesirable incident that occurs at time t⁰. Up until this time, system S has been operating at its optimal performance level, denoted as P_{O}. As time moves along after the occurrence of the undesirable incident, the performance of system S begins to degrade. This time is defined as t^{d} in FIG. 2. The performance continues to degrade (the curve in FIG. 2 being illustrative only), until the performance reaches its ‘worst’ (minimal) value of Pᵢ at time t^{m}. At some point in time (either before or after t^{m}), the occurrence of the undesirable incident is recognized by system S, where this event is noted to occur at time tⁱ. Later in time, the recovery process starts (shown as time t^{s}) and progresses until the system returns to its optimal performance level P_{O} at time t^{r}.

This resilience curve illustrates the four desirable properties in a resilient industrial control system (RICS) when it is properly designed and operated. These four properties can be defined as follows: (1) property 1: a RICS is engineered and operated in a way that the frequency of undesirable incidents can be minimized; (2) property 2: a RICS is engineered and operated in a way that most of the undesirable incidents can be mitigated; (3) property 3: a RICS is engineered and operated in a way that the adverse impacts of undesirable events can be minimized; and (4) property 4: a RICS is engineered and operated in a way that it can recover from the adverse impacts of undesirable incidents to normal operation in the shortest possible time.

An industrial control system can be defined as “i resilient” if the overall engineering system S within which the ICS operates is not adversely impacted by undesirable incident i. For example, a power grid automation system can be defined as “cyber attack resilient” if: (1) the control system has no exposure to hackers—the system is completely isolated; (2) the system has exposure points to hackers, but a firewall works efficiently to detect and block malicious data packets at the exposure points; or (3) the automation system possesses redundant devices and data paths and re-routes data packets to another path, or uses other devices to avoid any adverse impact when it detects cyber attacks.

As mentioned above, there is no known system in the prior art to specifically measure how resilient a specific industrial control system is, although there are reports on how to measure system resilience. For example, it is sometimes proposed in the prior art to measure resilience performance by buffering capacity, margin, tolerance, and the like. However, these metrics do not show how fast the system can recover from the undesirable incidents. Thus, in accordance with the present invention, specific metrics are proposed to estimate, rather than measure, the resilience of an industrial control system.

For the purposes of understanding the following discussion regarding resiliency of an industrial control system, the described parameters are summarized in the following Table I, “Notation and Description” and the associated metrics are summarized in Table II, “Resiliency Metrics for ICS”—

TABLE I
Notation and Description

| Notation | Description |
|---|---|
| S | A three-layered engineering system with an ICS in the |
| | central layer |
| p | Production |
| q | Quality |
| P | Performance |
| t⁰ | time that incident i occurs |
| t^{d} | time that system performance starts to degrade after the |
| | occurrence of incident i |
| t^{m} | time that system performance reaches bottom after occurrence |
| | of incident i |
| tⁱ | time that incident i is identified by ICS or system operators |
| t^{s} | time that system S begins to recover from incident I, the |
| | recovery either manually initiated by operators, or |
| | automatically initiated by the ICS |
| t^{r} | time that system S completely recovers from incident i |
| P_{O} | original system performance when incident i occurs |
| Pᵢ | minimum system performance due to incident i |
| μ | frequency of occurrence of incidents i |
| I | set of all possible undesirable incidents |
| I′ | set of all possible critical undesirable incidents, where I′ ⊂ I |
| M, N | subsets of all possible undesirable incidents |
| μ_{M,N} | frequency of occurrence of incidents M, but not N |
| L_{M,N} | overall potential financial loss from occurrence of incidents |
| | of M, but not N |

TABLE II
Resiliency Metrics for ICS

| Term | Notation | Description |
|---|---|---|
| Protection time | T^{p} | time that system S can withstand incident i without |
| | | performance degradation |
| Degradation | T^{d} | time that system S reaches its performance bottom |
| time | | due to incident i |
| Identification | Tⁱ | the time that system S identifies incident i |
| time | | |
| Recovery time | T^{r} | time that system S needs to recover to normal |
| | | operation after the initiation of incident i |
| Performance | P^{d} | maximum performance degradation of system S due |
| degradation | | to incident i |
| Performance | P^{l} | total loss of performance of system S due to incident i |
| loss | | |
| Total financial | Lᵢ | total financial loss of system S due to incident i, |
| loss | | which includes performance loss, equipment |
| | | damage and recovery cost |
| Overall | L | Overall financial loss due to all potential undesirable |
| potential loss | | incidents I |
| Overall | L′ | Overall financial loss due to all potential critical |
| potential critical | | undesirable incidents I′ |
| loss | | |

For an undesirable incident i, the following metrics, as defined above in Table II and illustrated in the resilience curve of FIG. 2, are proposed in accordance with the present invention to estimate the resilience of an industrial control system:
protection time T^{p}—which is defined as the time that system S can withstand incident i without performance degradation, where T^{p}=t^{d}−t⁰
degradation time T^{d}—which is defined as the time that system S reaches its performance bottom as a result of incident i, where T^{d}=t^{m}−t⁰
identification time Tⁱ—which is defined as the time that system S identifies incident i, where Tⁱ=tⁱ−t⁰. It is to be noted that Tⁱ is not necessarily greater than T^{d} since a well-designed and operated system S will be able to identify an undesirable incident before it reaches its performance bottom
recovery time T^{r}—which is defined as the time that system S needs to recover to normal operation from incident i, where T^{r}=t^{r}−t^{s}
performance degradation P^{d}—which is defined as the maximum performance degradation due to incident i, where P^{d}=P_{O}−Pᵢ
performance loss P^{l}—which is defined as the total loss of performance due to incident i, where P^{l}=P_{O}×(t^{r}−t⁰)−∫ₜ_{⁰}^{t}^{^{r}} P(t), and is shown as the shaded region in the resilience curve of FIG. 2
total loss Lᵢ—which is defined as the total financial loss due to incident i, which includes performance loss, equipment damage and recovery cost R^{c}, where Lᵢ=f(P^{l}, R^{c})
overall potential loss L—which is defined as the total financial loss as a result of all undesirable incidents over a given time interval
overall potential critical loss L′—which is defined as the overall loss due to all potential critical undesirable incidents I′ per year, where

$${\sum }_{{L}^{′} = ∀ M , N ⊆ {l}^{′}}^{ } {L}_{M , N} {μ}_{M , N} ,$$

where M,N⊂I′,M∩N=φ and M∪N=I′. Inasmuch as it is nearly impossible to enumerate all potential undesirable incidents, a reduced set I′ is used, where the quantity I-I′ represents those undesirable incidents that can be ignored due to their insignificance of probability or adverse impacts.
For engineering system S, it is assumed that there are two choices of an ICS, defined as ICS A and ICS B. ICS A is said to be more i-resilient than ICS B, or ICS A is more resilient than ICS B with respect to incident i if performance loss P^{l} and total loss Lᵢ associated with ICS A are less than those parameters of ICS B. Indeed, ICS A is said to be more resilient than ICS B if the overall potential loss L of ICS A is less than that of ICS B.

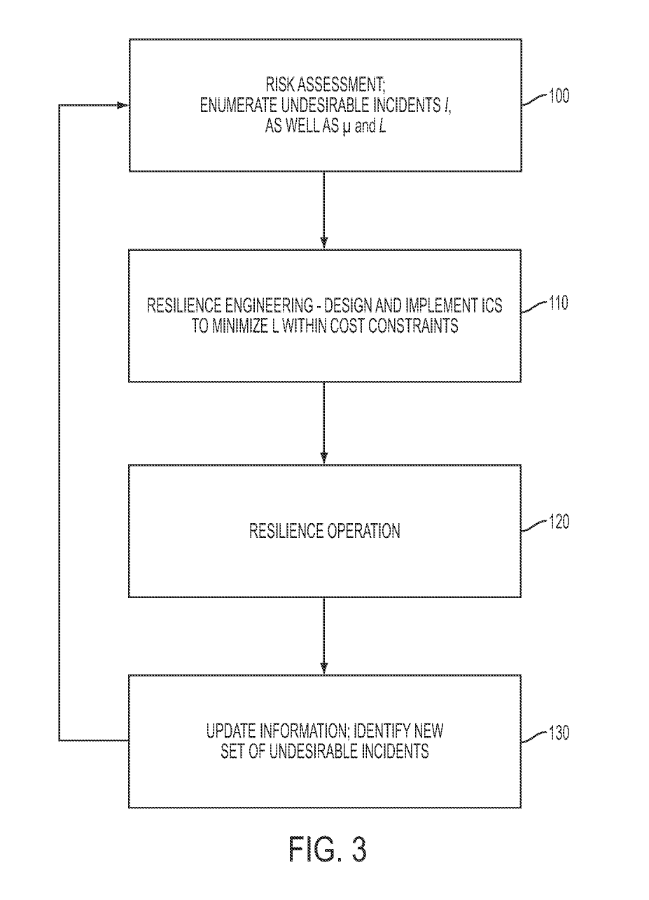

For the purposes of the present invention, a cyclic process is proposed as shown in the flowchart of FIG. 3 to obtain a quantitative estimate of the resilience of a given system. Referring to FIG. 3, the process begins at step 100 by performing a risk assessment that enumerates a set of critical incidents and, for each incident i, its frequency of occurrence μ and its financial loss Lᵢ. The resilience properties defined above are seen to show that adding resilience elements to an ICS is focused on dealing with undesirable incidents. This requirement necessitates a control design strategy shift from reactive methods to proactive methods, with consideration of assessing potential threats and taking necessary protection measures against them.

In order to minimize the frequency of occurrence and the adverse impacts of all possible undesirable incidents, the risk assessment step needs to first enumerate all possible critical undesirable incidents, which may occur at any of the three layers shown in the system model of FIG. 1. That is, a critical undesirable incident may include improper commands and invalid settings from operators at human level 12 of system 10. Additionally, incorrect messages from ICS 24 to operators at human level 12 could lead to the operators performing improper operations. Additional critical undesirable incidents may take the form of malfunctions and failures at automation level 14, such as malfunction/failure of sensors 18 and/or actuators 20, or communication failure between any various ones of sensors 18, actuators 20, HMI 22 and ICS 24. At process level 16, non-precise (or incorrect) models may also lead to the creation of critical undesirable incidents.

Within risk assessment step 100, once the critical undesirable incidents have been enumerated, the occurrence frequencyμ for each enumerated incident is analyzed. Also, the adverse impact of each critical undesirable incident on system S is analyzed and the associated financial loss Lᵢ is determined.

At the completion of the risk assessment, the process moves to step 110 and performs a resilience engineering operation (based on the enumerated critical undesirable incidents) that minimizes the overall financial loss L′ within given cost constraints. Engineering step 110 is considered as a two-step item, the first being the “design” of a specific resilient ICS and the second being the implementation of the designed, resilient ICS.

The design of a resilient ICS necessitates the novel interaction between two separate engineering disciplines: computer engineering and control engineering. From the control engineering point of view, the control of a complex, dynamic industrial control system is a well-studied area (such as advanced control technologies include robust control, adaptive control and the like). However, much less is known about how to improve control system tolerance to, for example, cyber attacks. As mentioned above, “resilience” as used in accordance with the present invention is defined as the superset of all the other properties (robustness, adaptiveness, survivability and fault-tolerance) blended with the ability to recover from an undesirable incident in as short a time as possible. Thus, resilient decision and control parameters need to be synthesized as augmentations of existing control decisions (such as robustness or adaptiveness) with the additional objective of reliable and fast recovery from the enumerated critical undesirable incidents. The proactive control design strategy needs to be considered all the way from design through the implementation stages at this point in the process.

Exemplary areas to be studied during engineering step 110 to improve system reliance are considered to include, but are not limited to: (1) minimization of the frequency of occurrence of undesirable incidents μ_{M,N}; (2) mitigation of undesirable incidents/minimization of adverse impacts of undesirable incidents; and (3) recovery in as short as time as possible. For example, the minimization of μ_{M,N} can be accomplished within a well-designed ICS 24 (see FIG. 1) that validates the inputs from HMI 22 by operator authentication and authorization, and input limits of data, thus providing the ability to identify invalid commands from the operator. Additionally, the value of μ_{M,N} can be minimized by validating input data to ICS 24 from sensors 18, passing only “correct” data to operators. Further, a well-designed ICS monitoring and prognosis tool will monitor and predict failures of key components, enabling operators to prevent such failures from occurring in the first place.

To mitigate undesirable incidents (or minimize their adverse impacts), as defined by L_{M,N}, one straightforward proposal is to build redundancy into the system. Redundancy, as a general paradigm, is perhaps the most widely-accepted and used implementation principle for creating a resilient system. As configured, a system makes use of redundant components along with the primary components, switching to the redundant components upon failure of a primary component. Additionally, a distributed control system may mitigate undesirable events by deploying control actions over a wide geographic area, allowing for the system to continue to operate if one area/controller fails. Further, the configuration of a system where the ICS is “aware” of its states and maintains a margin from its operation boundaries will also mitigate undesirable incidents.

To recover from a critical undesirable incident in the shortest possible time period (T^{r}), the engineering phase of resilience engineering step 110 needs to enable the control system to identify the undesirable incidents accurately and pass the corresponding information to operators, if they are in the control loop. Timely recovery is further assisted by providing a functionality that can generate backup recovery plans on-line (and automatically) for at least selected critical undesirable incidents and/or enabling the system to initiate the corresponding recovery plan as soon as the undesirable incident is identified.

Based upon the risk assessment performed in step 100 and the resilience engineering performed in step 110, the next step in the cyclic process of estimating resilience of an ICS in accordance with the present invention is defined as resilience operation (step 120). Resilience operation includes the functions of: state awareness, cyber attack awareness and risk awareness. With all real-time information, a resilient ICS is thus operated to minimize the potential financial loss of system S. To minimize the frequency μ_{M,N}, a well-designed and well-operated ICS will monitor system S and intelligently analyze real-time data and identify boundary conditions and operation margins. A well-designed and well-operated ICS will also pass analysis results to operators, providing operation suggestions to the operators.

To mitigate undesirable incidents (or minimize L_{M,N}), a well-designed and well-operated ICS generates and adjusts control strategies in an on-line fashion, according to detected undesirable incidents or potential incidents. Further, a well-designed and well-operated ICS is aware of its state, cyber attacks and risks, keeping a distance from the known boundaries. Lastly, a well-designed and well-operated ICS is able to interpret, reduce and prioritize undesirable incidents based on the information from state awareness, thus providing an adaptive capacity to perform corresponding responses (such as, for example, prioritized response to focus on mitigating the most critical incidents of parallel responses when resources are limited).

To recover in as short a time as possible, a well-operated ICS utilizes on-line techniques to accurately identify undesirable incidents and pass the corresponding information to the system operators. A well-operated ICS also uses on-line techniques to automatically generate backup recovery plans for detected undesirable incidents, while also initiating the corresponding recovery play as soon as the undesirable incident is identified.

As a result of the uncertainty and complexity of control system applications, control system re-engineering becomes inevitable to meet challenges that may have been ignored at the beginning of the process. Also, since it is difficult to enumerate all undesirable incidents and estimate their probabilities, risk assessment cannot be considered as a one-time event. Thus, after a given period of operational time, the process of the present invention will move to step 130, where the identities and values of both I′ and L′ are re-analyzed and updated. The additional body of data associated with the operation of system S is useful in preparing this update. Additionally, with this updated information, new control strategies can be developed during engineering and executed during operation, leading to further improvements in resiliency. As shown in FIG. 3, therefore, once the updating is completed, the process returns to step 100 and again performs a risk assessment. The ability to continuously cycle through this process ensures the continued resiliency of the ICS.

### EXAMPLE

### Cyber-Attack-Resilient Power Grid Automation System

The principles of the present invention can be further understood by way of example, in this case the example being a cyber-attack-resilient power grid automation system. Approaches to improving the resiliency of a power grid automation system with respect to cyber attacks are presented. A cyber risk assessment model, as well as a framework for protecting the power grid from cyber attacks, is disclosed.

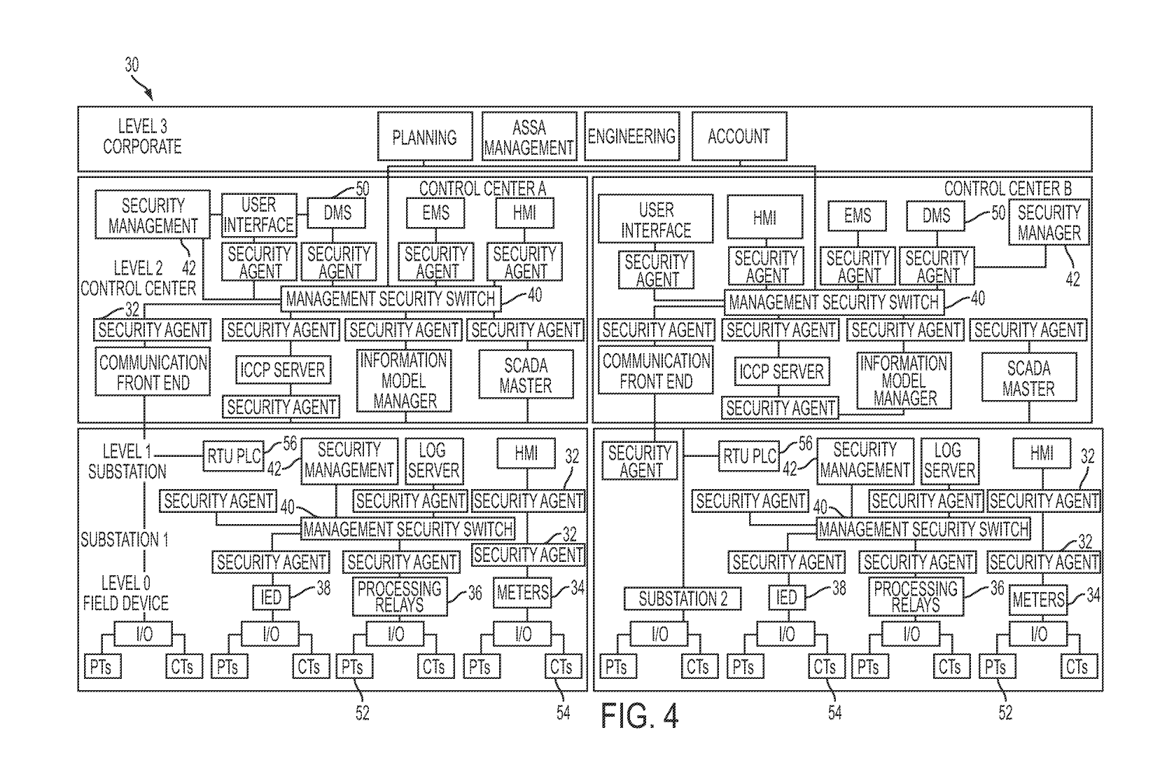

The emerging “smart” power grid requires a conventional power grid to operate in a manner that was not originally intended. In particular, in order to bring more participants into the system, a smart grid will open the originally-isolated automation network to more individuals, perhaps even the public at large. This degree of openness brings considerable concerns with respect to cyber security issues and the vulnerability of power grid automation systems to cyber attacks. Therefore, to improve the cyber attack resilience of such a power grid automation system, a security solution framework with the following three major elements is proposed, as shown in FIG. 4.

The first major element is defined as a “dynamic and evolutionary risk assessment model”. This risk assessment model (associated with step 100 of the flowchart of FIG. 3) assesses the critical assets of the power grid. It uses dynamic, quasi-real time simulations to reveal potential vulnerabilities. The model is configured to detect both previously-known and currently-unidentified security events and activities. Using the existing topology of the power grid, a risk assessment graph is created which dynamically evolves through design and real world operation. The graph is then translated into a Bayesian network, where edges are weighted according to pre-defined economical measures and business priorities. The model provides a list of assets with utility functions that reflect the associated risks and economic loss.

To construct a general model for risk assessment, an integration of physical features of power grids and substations with cyber-related risks and security characteristics of such systems is required. In order to make the model practical, a level of aggregation in cyber security analysis is considered to avoid complexity and dimensionality, which cannot be implemented with existing calculation capacities. Therefore, in accordance with this exemplary embodiment of the present invention, the proposed framework is decomposed as follows: (1) the “first pass” model runs at the grid level to identify the substations most critical/strategic to the proper operation of the power grid; and (2) the “second pass” model runs at the substation level to identify the components most critical/strategic to the operation of each substation identified in the first pass.

This risk assessment model can be run both off-line and on-line. When running off-line, it receives inputs including power grid topology, substation primary circuit diagrams, statistical power flows and automation system topology. The model calculates and outputs all potential loss associated with cyber attacks against critical components in substations. This output information can then assist power grid operators to find critical cyber security assets and understand the potential loss L′ related to cyber attacks on these assets.

When running on-line (at the resilience operation stage, step 120, for example), the inputs of this model replace statistical power flow data with real-time power flow data. The outputs L′ are the same as those developed in the off-line model. Here, the results can help an operator identify critical security assets and understand the potential loss associated with cyber attacks based on real-time information, and further improve its resilience during both resilience operation enhancement stages.

The second major element in the security solution framework is defined as an integrated and distributed security system 30, as shown in FIG. 4. Security system 30, as explained in detail below, is configured to overlay the intelligent power grid network in a hierarchical/distributed manner. System 30 includes a plurality of security agents 32 that reside next to (or are integrated within) various devices and controllers, such as meters 34, protective relays 36 and intelligent electronic devices (IEDs) 38. As shown in FIG. 4, system 30 further includes distribution management systems (DMSs) 50 that communicate via security agents 32 with their respective managed security switches 40. At the “bottom” of the substation level, a plurality of potential transmitters (PTs) 52 and current transmitters (CTs) 54 are also shown.

Security agents 32 function to provide end-to-end security within system 30. Security agents 32 bring security to the edges of system 30 by providing protection at the networked device level. Security agents 32 are configured as firmware or software agents, depending on the layer of the control hierarchy. In particular, at the field device layer (i.e., associated with IEDs 38, protective relays 36 and meters 34), security agents 32 are less intelligent, containing only simple rules and decision-making capabilities. At this level, security agents function more to perform event logging and reporting.

At higher control levels (i.e., with RTU/PLC 56), security agents 32 are more intelligent, with complex rules for identification and detection of intrusive events and activities. In particular, at this level security agents 32 are tasked to accomplish the following functionalities: (1) acquire and run the latest vulnerability patches from an associated security manager 42 (the functionality of security manager 42 described in more detail hereinbelow); (2) collect data traffic patterns and system log data, reporting this information to its security manager 42; (3) analyze traffic and access patterns with varying complexity depending on the hierarchical layer; (4) run host-based intrusion detection; (5) detect and send alarm messages to its security manager 42 and, perhaps other designated devices such as HMI 22; (6) acquire access control policies from its security manager 42 and enforce them; and (7) encrypt and decrypt exchanged data.

Also shown as a component of system 30 is a plurality of managed security switches 40, where each managed security switch 40 functions to control the Quality of Service (QoS) in terms of delay and bandwidth. These managed security switches 40, functioning as network devices, connect controllers, RTUs, HMIs and servers in the substation and control center. Each managed security switch 40 possesses the following functionalities: (1) separates external and internal networks, “hiding” the internal network and running NAT/NPAT (Network Address Translation/Network Port Address Translation); (2) acquires bandwidth and allocation patterns and data prioritization patterns from its associated security manager 42; (3) separates data according to prioritization patterns, such as operational data, log data, trace data and engineering data; (4) provides QoS for important data flow, such as operations data, guaranteeing its bandwidth and delay; (5) manages multiple Virtual Local Area Networks (VLANs); and (6) runs simple network-based intrusion detection programs.

A plurality of security managers 42 are also included within system 30, each coupled to a separate one of the managed security switches 40 and utilized to manage cyber security-related engineering, monitoring, analysis and operation. Security managers 42 can be protected by existing IT security solutions and are able to connect to a vendor's server, managed switches and security agents through a Virtual Private Network (VPN). In accordance with the present invention, a security manager 42 provides the following functionality: (1) collects security agent information; (2) acquires vulnerability patches from a vendor's server and download the patches to the corresponding agents; (3) manages cryptographic keys; (4) works as an “authentication, authorization and accounting” (AAA) server, which validates user identifications, authorizes user access rights, and records the modifications users have made to the controllers; (5) collects data traffic patterns and performance matrix information from agents and switches; (6) collects and manages alarms/events from agents and switches; (7) generates access control policies based on the collected data and downloads the policies to the agents; (8) runs complex intrusion detection algorithms at the automation network levels; and (9) generates bandwidth allocation patterns and data prioritization patterns and downloads them to the managed network switches.

In accordance with the present invention, security system 30 enables power grid operators to monitor, analyze and manage cyber security of the power grid by monitoring communication traffic, detecting possible cyber attacks and minimizing the adverse impacts of those cyber attacks.

Lastly, the third major element of the defined security solution framework of the present invention comprises a security network topology optimization model, where this model is utilized to optimize the topology of the security system without compromising the performance of the control functionalities. Based on the result of the risk assessment model (in this example, associated with the most vulnerable components such as RTUs and communication links), the security optimization model functions to help power grid operators develop security agents 32 and managed security switches 40 with the proper levels of cost, bandwidth and data delay requirements. By virtue of including the security agents and managed security switches, the resilience of the system to cyber attacks is significantly improved during the engineering stage of the system. This model also helps operators adjust security policies to improve cyber attack resilience during resilience operation and enhancement stages, according to on-line risk assessment results and any detected cyber intrusions.

The cyber-attack-resilient power grid automation system of this example is thus shown as being engineered and operated in a way such that: (1) the system is aware of power grid operation states, cyber attacks and their potential adverse impacts on power grid operation by on-line risking assessment and intrusion detection; (2) the system analyzes which cyber attacks are and where they occur, passing this information on to the operators; (3) the system mitigates detected cyber attacks by adjusting corresponding security policies, such as access control in security agents; (4) the system can minimize the adverse impacts by re-routing data paths from the attacked communication link or re-directing power flows from the attacked substations if these cyber attacks cannot be mitigated; and (5) the system helps operators re-route data paths from an attacked communication link or re-direct the power flow from a compromised substation, allowing for quick recovery to normal operation.

While the invention has been disclosed in connection with preferred embodiments shown and described in detail, their modifications and improvements thereon will become readily apparent to those skilled in the art. Accordingly, the spirit and scope of the present invention should be limited only by the following claims.

What is claimed is:

1. A method of providing a quantitative estimate of the resilience of an industrial control system, the method comprising the steps of:
a) enumerating a plurality of undesirable incidents associated with the industrial control system, the plurality of undesirable incidents including incorrect messages from the industrial control system to human operators leading to the human operators performing improper operations on the industrial control system;
b) performing a risk assessment for the industrial control system based upon the plurality of undesirable incidents;
c) designing and implementing an industrial control system to minimize financial loss associated with the plurality of undesirable incidents, including enabling the industrial control system to pass information identifying the undesirable incidents to the human operators;
d) operating the industrial control system designed and implemented in step c);
e) enumerating an updated plurality of undesirable incidents based upon the operation of the industrial control system; and
f) repeating steps b) through e) to continue to enhance the quantitative estimate of the resilience of the industrial control system.

2. The method as defined in claim 1 wherein in performing step b), the risk assessment includes determining the frequency of occurrence μ of each undesirable incident i and its associated total financial loss Lᵢ to an overall engineering system supported by the industrial control system.

3. The method as defined in claim 2 wherein the total financial loss Lᵢ is defined as including: (1) a performance loss P^{l} defined as a total loss of performance of the overall engineering system due to the undesirable incident; (2) equipment damage within the overall engineering system; and (3) the recovery cost associated with returning the operation of overall engineering system to its original performance level.

4. The method as defined in claim 1 wherein in performing step c), the industrial control system is designed to minimize the frequency of each enumerated undesirable incident.

5. The method as defined in claim 1 wherein in performing step c), the industrial control system is designed to mitigate at least one of the enumerated undesirable incidents.

6. The method as defined in claim 1 wherein in performing step c), the industrial control system is designed to minimize the adverse impacts of at least one of the enumerated undesirable incidents.

7. The method as defined in claim 1 wherein in performing step c), the industrial control system is designed to minimize the time required for the overall engineering system to recover to its original performance level.

8. A resilient industrial control system comprising:
a first set of communication links with a human interaction layer, the human interaction layer for transmitting operating instructions to the resilient industrial control system and receiving monitoring data therefrom; and
a second set of communication links with a plurality of sensors, a plurality of actuators, the sensors and actuators coupled to a process layer with the plurality of actuators transmitting execution instructions to the process layer and the plurality of sensors receiving measurements from the process layer;
wherein the first set of communication links provides messages from the industrial control system to human operators leading to the human operators to perform operations on the industrial control system;
the resilient industrial control system being enabled to pass information to the human operators identifying an undesirable incident wherein incorrect messages are provided from the industrial control system to the human operators leading the human operators to perform improper operations on the industrial control system.

9. A resilient industrial control system as defined in claim 8 wherein the system further comprises a third set of communication links with a human machine interface disposed at-an interface with the human interaction layer.

10. An engineering system providing resilience in its industrial control system, the engineering system comprising
a human operations layer for transmitting operating commands and monitoring responses to the operating commands;
an automation layer including actuators for receiving the operating commands transmitted by the human operations layer and sensors for transmitting monitoring responses to the human operations layer, the automation layer further comprising an industrial control system for receiving signals from the sensors and transmitting controls to the actuators; and
a process layer for receiving the commands from the actuators to control the engineering system and transmitted measured system responses to the sensors.
wherein the monitoring responses transmitted to the human operations layer lead human operators to perform operations on the industrial control system;
and wherein the monitoring responses further include monitoring responses identifying an undesirable incident wherein incorrect messages are provided from the industrial control system to the human operators leading the human operators to perform improper operations on the industrial control system.

11. The engineering system as defined in claim 10 wherein the automation layer further comprises a human machine interface disposed between the industrial control system within the automation layer and the human operations layer, the human machine interface for receiving additional operating commands from the human operations layer and forwarding the additional operating commands to the industrial control system, and also for transmitting additional monitoring data from the industrial control system to the human operations layer.

12. A method of quantitatively estimating the resilience of an industrial control system, the method including the steps of:
a) defining a plurality of metrics associated with resilience of an industrial control system, the metrics including: (1) a performance loss P^{l} which is defined as a total loss of performance of an engineering system utilizing the industrial control system due to an undesirable incident I, where P^{l}=P_{O}×(t^{r}−t⁰)−∫ₜ_{⁰}^{t}^{^{r}} P(t), where P_{O} is defined as an original system performance prior to the initiation of the undesirable incident, t^{r} is defined as the time the engineering system recovers from the undesirable incident and t⁰ is defined as the time that the undesirable incident occurs; and (2) a total loss Lᵢ which as defined as a total financial loss associated with an undesirable incident;
b) determining the value of the defined metrics for a plurality of identified undesirable incidents; and
c) determining an overall potential system loss L′ which is defined as an overall loss due to all potential undesirable incidents, where L′=Σ_{∀M,N⊂I}, L_{M,N}×μ_{M,N} and M and N are defined as subsets of all possible undesirable incidents, L_{M,N} is defined as the overall potential financial loss associated with the occurrence of incidents in subset M, but not subset N, and μ_{M,N} is defined as the frequency of occurrence associated with the incidents in subset M, but not subset N, the overall potential system loss used as a quantitative estimate of the resilience of the industrial control system.
